(19) United States
(12) Patent Application Publication
(10) Pub. No.: US 2011/0206809 A1
(43) Pub. Date: Aug. 25, 2011

(54) Compositions and methods for making animal feeds having shapes of natural food sources

(76) Inventor: Jeff Tate, Hardingsburg, KY (US)

(21) Appl. No.: 12/660,172

(22) Filed: Feb. 22, 2010

(51) Int. Cl. A23K 1/16; A23P 1/10; A23L 1/303

(52) U.S. Cl. 426/73; 426/512; 426/242; 426/310; 426/456; 426/464; 426/74

(57) ABSTRACT

The present invention provides a non-naturally occurring animal feed and attractant that mimics the shape of a naturally occurring object, such as a food source, and has a size and shape that is easier to hold than traditional feeds. The invention provides a non-naturally occurring animal feed having a more durable, chemical-free water resistant seal that is safer and more environmentally sustainable. The invention provides a non-naturally occurring animal feed having a combination of minerals, vitamins, and other ingredients designed to promote deer healthiness and antler growth. Furthermore, the present invention provides methods and processes for manufacturing embodiments of the inventive non-naturally occurring feed.

### FIELD OF THE INVENTION

The present invention relates generally to compositions and methods for making non-naturally occurring animal feed. More particularly, the present invention pertains to a non-naturally occurring feed possessing enhanced properties, including as an attractant or resistant.

### BACKGROUND OF THE INVENTION

Those who work closely with or interact with animals, such as pet owners, zoo keepers or custodians, hunters, nature preserve rangers, and others, often provide feed to animals they interact with. In addition to naturally occurring food sources, there exist non-naturally occurring feeds. One example of a non-naturally occurring feed is a product sold by Evolved Habitats under registered trademark ACORN FRENZY®, which contains white oak acorns, soybeans and bran. Another example of a non-naturally occurring feed is a product sold by Wildgame Innovations called Acorn Rage (the full extent of which is protected by trade secret), which contains soybeans and acorns.

Generally, common uses and purposes of non-naturally occurring feeds include promoting health in and growth of the animal, minimizing harm to the environment, and attracting ruminants to specific locations and/or away from other locations. Non-naturally occurring feeds are typically deposited on the ground of browsing sites where animals, such as ruminants or other animals, will feed or are known to feed. Common browsing sites include but are not limited to parks, zoos, commercial safaris, hunting sites, and any other site intended for public and private viewing, photography, or hunting. Additionally, feeds are also used in the natural habitat of animals and in other natural settings where animals may browse.

More specifically, uses and purposes of non-naturally occurring feeds include providing primary or supplemental sources of food for the subject animals, serving as an attractant to lure certain animals to desired locations (or to lure them away from other locations), supplementing the animal's diet with nutrients that are scarce or are not found in local food sources, introducing a medication or drug into the animal, and measuring activity or presence of animals at an observed location. For instance, to enhance the viewing pleasure of its patrons, a zoo may periodically place non-naturally occurring feeds at locations within confined areas to promote observation of zoo animals. Another example of the use of non-naturally occurring feeds is the placement of such feeds by hunters at desired hunting locations to aid in the sport of hunting. This technique, which may be referred to as “baiting” a location, could be also employed on a commercial basis. Additionally, non-naturally occurring feeds may be used to lure animals to a location and away from another location, e.g., to lure bears away from populated areas. Use of non-naturally occurring feeds may be ad hoc or over a sustained period of time in a systematic fashion. Researches involved in studying animal behavior may use non-naturally occurring feeds as well.

While non-naturally occurring feeds provide many uses and purposes, one drawback, which has heretofore been unrecognized in the prior art, is that they give off the appearance of having been unnaturally planted or placed in the location, which is less desirable to animal enthusiasts and hunting purists. Animals are also less likely to accept non-naturally occurring feeds given the unnatural appearance. Given these drawbacks, existing non-naturally occurring feeds are not as effective at driving the desired animal behavior. Furthermore, unnaturally shaped feeds are not as effective at creating a desirable viewing or hunting experience for patrons or users.

The shape of non-naturally feeds also presents other related problems. At zoos, patrons often have access to feed dispensers, which allow them to purchase non-naturally occurring feed to deposit on the ground or hold up to animals. However, the non-naturally occurring feeds in such dispensers are often either crushed into flakes or shaped as small pellets. This makes the feed difficult to receive from a dispenser and similarly difficult to hold without partially spilling. This aspect of non-naturally occurring feeds hinders its intended use.

Non-naturally occurring feeds may possess enhanced environmental properties, such as a seed coating designed to pass the feed through the ruminant's digestive tract for purposes of reseeding after consumption. Other non-naturally occurring feeds possess enhanced properties for promoting animal health and growth. Typically, feeds include minerals, vitamins, fats, and many other ingredients, supplements, and additives. Some of these ingredients may be dry, herein defined as “dry ingredients.” One example of an ingredient that is not dry is molasses.

Some non-naturally occurring feeds are least partially resistant to the effects of water, snow, etc. This provides enhanced durability in a wider range of environmental circumstances. Non-naturally occurring feeds that are capable of withstanding heavy rainfall, snowfall, etc. save the user time, energy, and money that would otherwise be spent resupplying feeds that deteriorate quickly in certain climates. Furthermore, water resistant feeds provide ruminants with access to important nutrients and dietary supplements during more extreme weather conditions, when natural food sources may be scarcer or harder to find.

So, water resistance is a highly desirable property in non-naturally occurring feeds. Unfortunately, known non-naturally occurring feeds only retain their water resistant properties for very limited amounts of time. Another drawback of traditional water resistant feeds is that many of these feeds use chemicals to achieve their water resistant properties. These chemicals can potentially cause harm to the environment once they wash off the feed and are absorbed into the ground. Furthermore, they introduce foreign and unnatural substances into the animal, which can potentially cause the animal short-term and long-term harm.

What is needed is a solution to address the various problems associated with feeds having a shape that is visually unappealing or difficult to hold. Additionally, what is needed is a solution to address the problems associated with water resistant feeds that wear down after extended exposure to rain, or that contain potentially harmful chemicals.

### SUMMARY OF THE INVENTION

The present invention provides a non-naturally occurring feed and attractant for animals, including deer and other ruminants, as well as other animals such as squirrels, chipmunks, rabbits, and other animals. The term “ruminant” encompasses deer, cows, goats, sheep, camels, and other cud-chewing, hoofed mammals of the suborder Ruminantia. More specifically, the present invention encompasses non-naturally occurring feeds that have the appearance of a naturally occurring food source, e.g. acorn, walnut, beech nut, hedge apple, wild blackberry, hickory nut, etc. Furthermore given that pieces of these nuts occasionally become disassociated, the invention also encompasses such disassociated pieces, such as the bottom portion of an acorn without its cap, as well as the cap of an acorn without the bottom portion. The present invention is appropriate for many uses in a wide variety of settings, including in parks, zoos, commercial safaris, the wild, and any other site used for viewing, hunting, photography, etc. Intended purposes and functions include promoting animal health and growth (or some physical attribute of an animal, such as the antlers of a male deer), attracting animals to a particular location and/or away from other locations, and/or to promoting environmental safety and sustainability, as well as other functions readily appreciated by one of ordinary skill in the art. In addition to its novel and nonobvious solutions to the problems mentioned above, the present invention also encompasses the recognition of those previously unidentified problems in the art.

In one aspect, the invention provides a non-naturally occurring animal feed/attractant that mimics the shape of a naturally occurring food source, e.g., acorn, walnut, beech nut, hedge apple, wild blackberry, hickory nut, etc.

In another aspect, the invention provides a non-naturally occurring animal feed/attractant having a size and shape that is easier to hold than traditional feeds.

In another aspect, the invention provides a non-naturally occurring animal feed/attractant having enhanced water resistant properties.

In another aspect, the invention provides a water resistant feed having enhanced properties for environmental safety and sustainability.

In another aspect, the invention provides a non-naturally occurring animal feed/attractant having minerals, vitamins, and other ingredients designed to promote deer healthiness and antler growth.

### BRIEF DESCRIPTION OF DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 is a flow chart showing an overview of the manufacturing process for a first embodiment of the invention.

FIG. 2 is a flow chart showing an overview of the manufacturing process for a second embodiment of the invention.

FIG. 3A-3B are diagrams showing side views of injectors, which are used for injecting batter into a mold.

FIG. 4 is diagram of a mold, injector bin, and conveyor belt used to produce acorn-shaped feed pellets.

FIG. 5 is a diagram showing a top view of the bottom plate of the mold shown in FIG. 4.

FIG. 6 is a diagram showing a side view of the top plate of the mold shown in FIG. 4.

FIG. 7 is a diagram showing a side view of the acorn-shaped cavities of the mold shown in FIG. 4.

FIG. 8 is a diagram showing a side view of the top and bottom plates of the mold shown in FIG. 4.

### DETAILED DESCRIPTION OF PREFERRED EMBODIMENT

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

When referring to “water resistant” properties of the invention, the invention's ability to “resist water,” or any other variation thereof, what is being described is the ability to diminish penetration of water, dew, snow, animal urine, etc. into the feed product, thereby resisting the effects of exposure to those liquids. According to the definition provided herein, a water resistant feed need not achieve its water resistant properties by applying an external coating to the surface of the feed, but rather need only provide diminished penetration of liquids into the feed product. Further, based on this definition, the water resistant capabilities of feeds may be evaluated according to how much of the original shape and rigidity is maintained when the feed is subjected to water, such as rain conditions.

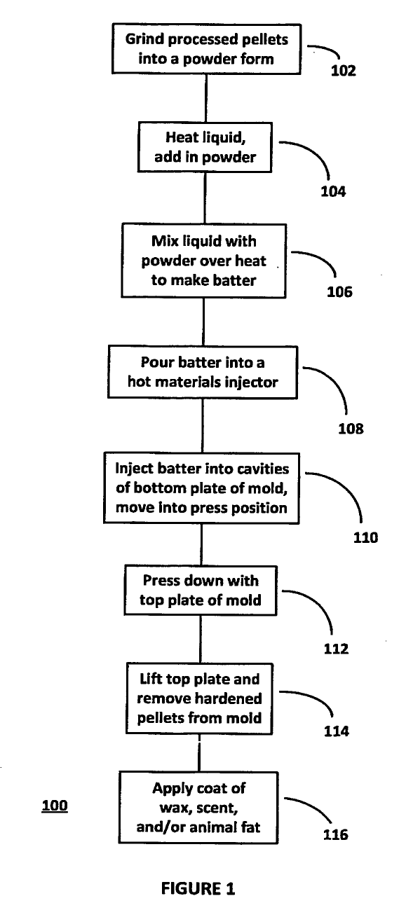

FIG. 1 is a flow chart showing an overview of a manufacturing process for producing an exemplary embodiment of the invention. In the first step, processed pellets are ground into a powder form, shown in block 102 from FIG. 1. In the alternative, some or all of the ingredients to be included may be supplied in powder form. The processed pellets can be supplied by a feed company. The pellets preferably comprise a combination of dry ingredients, the combination and respective portions of which may vary, shown in TABLE 1 below. It is not necessary to include all or even a majority of the exemplary ingredients shown in TABLE 1, and additional ingredients may be added to the mix. Although ranges are shown in TABLE 1, these are exemplary and do not limit the invention.

TABLE 1

| Ingredient | % by Weight |
|---|---|
| Grain Products | 50-60 |
| Processed Grain By-Products | 20-25 |
| Plant Protein Products | 20-25 |
| Pellet Binder (e.g., Amerabond) | 1-1.5 |
| Molasses | 4.17-6 |
| Limestone | 1-5 |
| Urea | 1-2 |
| Dicalcium Phosphate | 0.5-1 |
| Salt | 0.5-1 |
| Trace Minerals | 0.05-1 |
| Vitamins A, D, and E | 0.03-0.08 |
| Crude Fat | 1.5-3 |

In addition to these ingredients, other optional ingredients include roughage products, calcium carbonate, monocalcium phosphate, forage products, molasses products, biotin, sodium bentonite, lignin sulfonate, calcium bentonite, sodium selenite, zinc oxide, cobalt glucoheptonate, zinc amino acid complex, manganese amino acid complex, copper amino acid complex, manganous oxide, magnesium oxide, copper sulfate, manganese sulfate, zinc sulfate, ethylenediamine dihydriodide, cobalt carbonate, and ferrous sulfate.

In the next step, a liquid is mixed and heated in a suitable container such as a metal vat, shown in block 104. In this step, the ingredient powder is also added. The liquid can comprise sugar-based compositions that, when heated, become a liquid. Prior to being heated, however, the sugar-based composition can take on other forms, so long as those forms are suitable for being mixed and molded once heated. For example, in some embodiments the sugar base comprises granulated sugar, which, when heated, becomes a liquid. In an exemplary embodiment, the sugar base comprises molasses. In other embodiments, water or water-based liquids are used.

Once the sugar base reaches a boil, the powder from step 102 is added into the pot with the boiling sugar base, forming a powder-sugar mixture or slurry. In one exemplary embodiment, the powder makes up about 40% by weight of the mixture. The mixture is mixed over heat until a sufficiently homogenous and substantially liquid batter is produced, shown in block 106. In an exemplary embodiment, the batter is boiled for 10 minutes at a temperature of about 270° F., until it is at least 140° F. in temperature. However, the invention is not limited to these specific times or temperatures. Additionally, wax products such as paraffin or baker's wax can be added to the mixture. In an exemplary embodiment, wax is added to the mixture and makes up about 7% by weight of the mixture. Similarly, scents and/or attractants, such as acorn scent, apple scent, and other attractants, can also be included in the batter for enhanced attractant properties. In an exemplary embodiment, acorn scent is added.

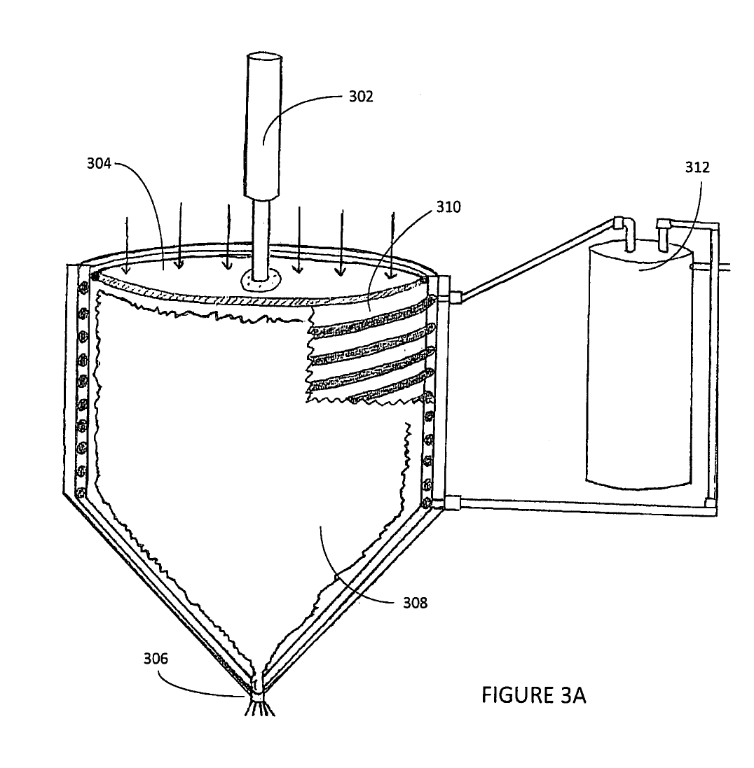

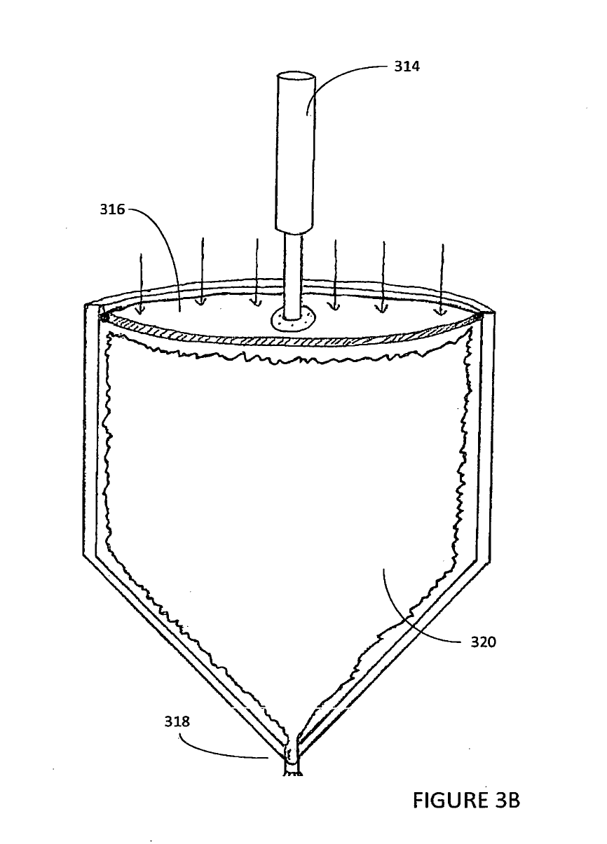

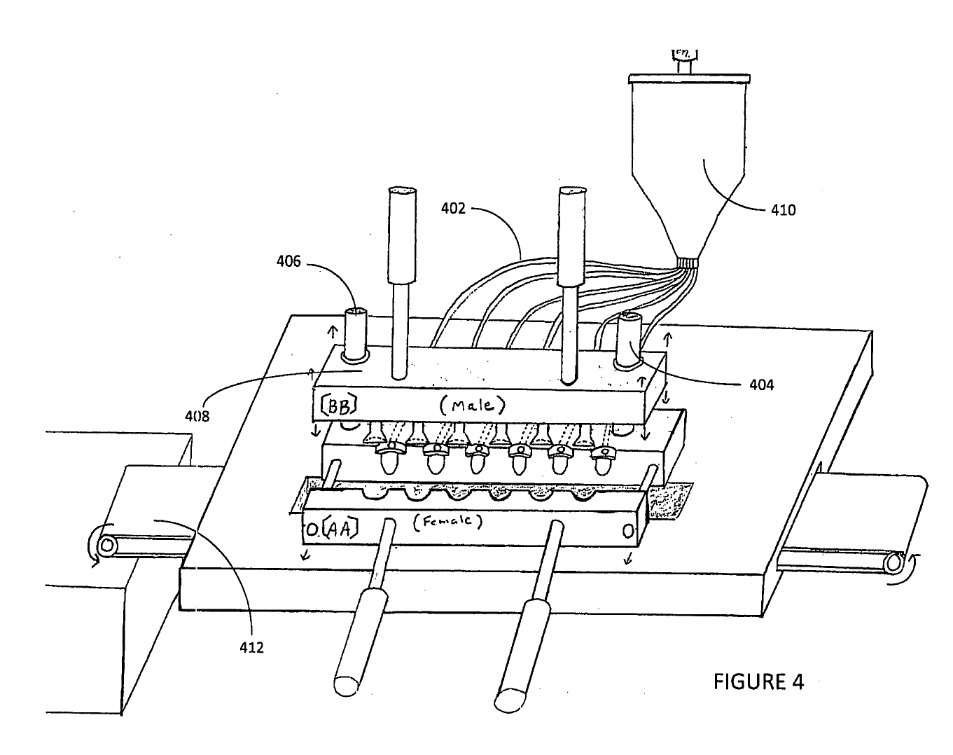

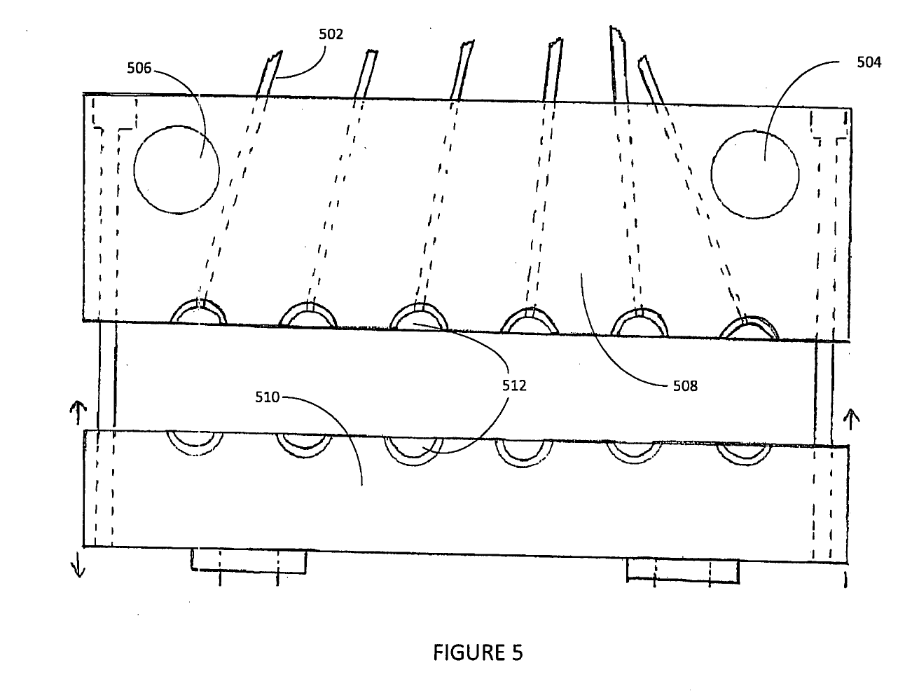

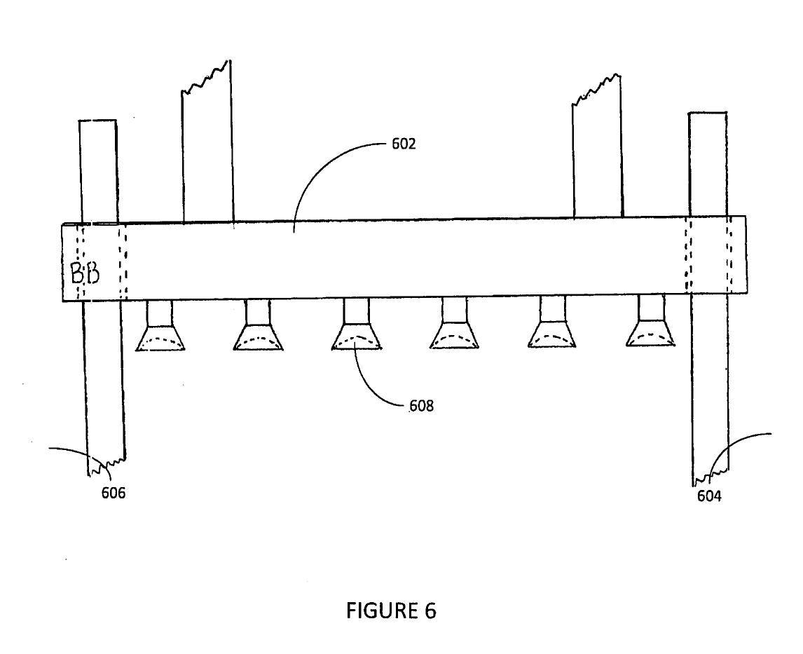

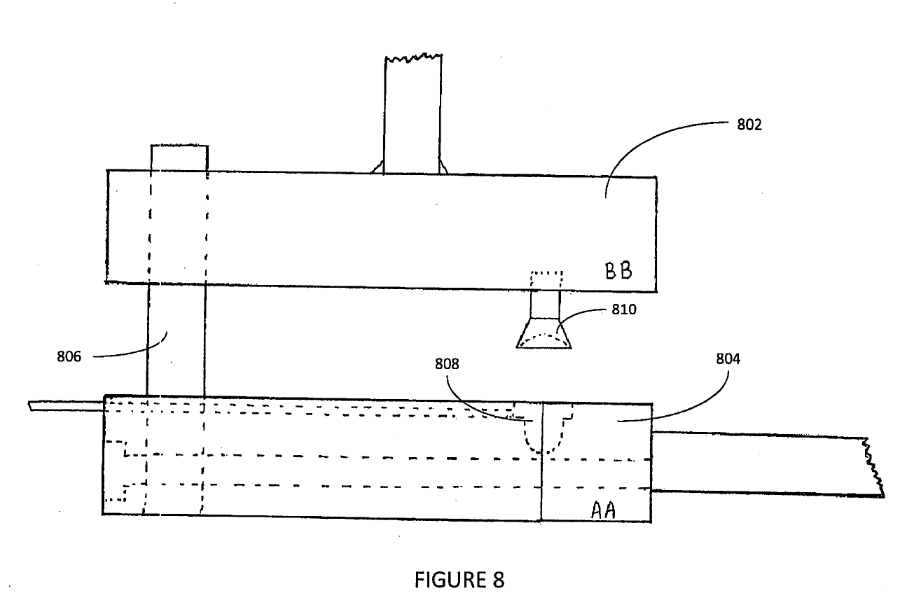

In the next step, shown in block 108, the heated, finished batter is poured into a hot materials injector. The hot materials injector keeps the batter from setting until it is injected into the mold. An exemplary embodiment uses a hot materials injector such as the one shown in FIG. 3A. The hot materials injector of FIG. 3A comprises an air cylinder 302, a plunger 304, a spout 306, and an outer lining 308 that contains hot water tubes 310. The water in the tubes can be heated using hot water heater 312. Hot water circulates through the tubes in the outer lining of the injector, thereby heating the contents of the injector and keeping the batter from setting or taking the form of the bin. FIG. 4 shows a mold 408, injector bin 410 (such as one from FIG. 3A or FIG. 3B), and conveyor belt 412 used to produce acorn-shaped feed pellets. The spout 304 is connected to feed tubes 402, shown in FIG. 4, which feed the batter into the mold 408. The mold 408 has top plate 802 and bottom plate 804, shown in FIG. 8. In the next step, shown in block 110, the hot batter is injected into the bottom plate 804 of the mold 408. FIG. 5 shows a top view of the bottom plate from FIG. 8. The bottom plate is separable into back section 508 and front section 510. Guideposts 504 and 506 keep the plates in place horizontally while vertically moving into and out of pressing position (see also guideposts 404 and 406 of FIG. 4, and guideposts 604 and 606 of FIG. 6). When the back section 508 and front section 510 are compressed together in a closed position, cavities 512 form the shape of a bottom portion of an acorn. Batter enters the bottom cavities through the feed tubes 502, which are connected to the hot materials injector. FIG. 6 shows a side view of the top plate from FIG. 8. The top plate 602 has cavities 608 shaped to substantially mimic the top portion of an acorn. Like the bottom plate, the top plate 602 is guided into position by guideposts 604 and 606. The mold described herein is one particular mold used for making an exemplary embodiment of the invention and does not limit the invention. In particular, other embodiments are made from different molds also having acorn-shaped cavities. Further, other embodiments are made from different molds having cavities shaped like other naturally occurring objects.

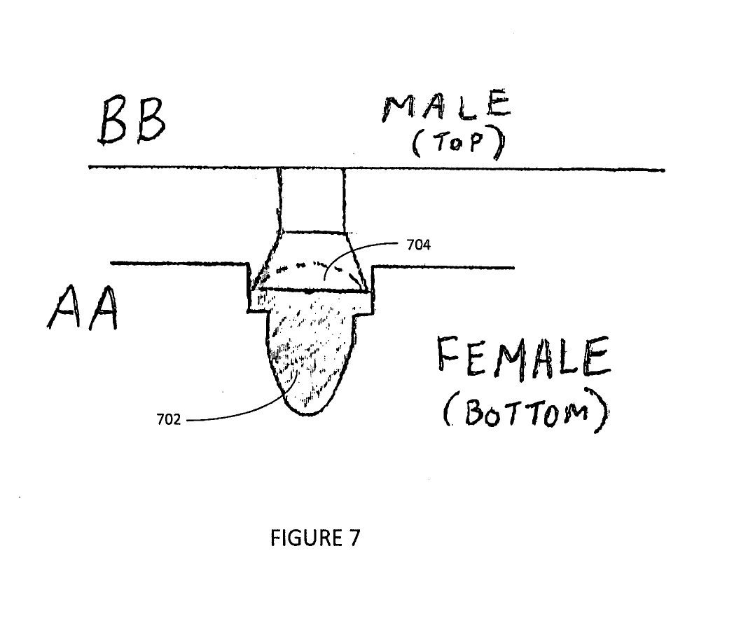

When the mold is pressed, the cavities of the top plate line up with the cavities of the bottom plate such that each of the bottom and top cavities cooperatively form the shape of an entire acorn. The whole acorn cavity is shown in detail in FIG. 7; see top acorn portion 704 and bottom acorn portion 702. FIG. 8 further shows the cooperation of the top and bottom plates. When the top plate 802 and bottom plate 804 press together, bottom acorn portion 808 lines up with top acorn portion 810, such that an entire acorn is formed. FIG. 8 also shows guidepost 806 for guiding the bottom plate while in motion. Each whole acorn cavity is about 1 inch in height and 1 inch in width. The exact dimensions may vary slightly to give some degree of variation among the acorns processed. Once the bottom plate has been filled with batter, it is moved into position and pressed by the top plate, shown in block 112. In this step, the top plate comes down with a pressure of about 300 PSI to shape the batter. Steps 110 and 112 occur quickly, in about 30 seconds total, in order to prevent the batter from setting before being pressed by the top plate. Once the mold has been set, the top plate is lifted back up away from the bottom plate. The acorn-shaped feed pellets are then removed from the bottom plate using injector pins located in the bottom of each cavity, shown in block 114.

The final step, shown in block 116, is an optional step of coating or covering the acorn-shaped pellets. In some embodiments the acorn-shaped pellets are covered with attractants and/or scents, such as acorn scent, apple scent, or other attractants. In other embodiments, the acorn-shaped pellets are covered in wax such as paraffin or baker's wax. In other embodiments, the acorn-shaped pellets are covered in animal fat. Covering the acorn-shaped pellets in a scent/attractant helps attract animals to the feed once it is deposited onto the ground. Covering the pellets in wax and/or animal fat provides additional water resistance that is capable of withstanding exposure to outdoor conditions, including rain, dew, snow, etc., for prolonged periods of time. In an exemplary embodiment, a coating of wax is added. Approximately 9 grams of coating is used per pound of acorn-shaped pellets. These weights, sizes, and amounts are exemplary and do not limit the invention.

One embodiment resulting from the manufacturing process described herein is an exemplary deer feed pellet having a shape of an acorn and comprising wax, scent, molasses, the ingredients and their portions listed in Table 1, and water resistant properties without the addition of harmful chemical substances. The final weight of the exemplary acorn-shaped pellets described herein is about 10.5 grams. Other methods of manufacturing may also be used to arrive at the same exemplary embodiment described herein. The invention is not limited to this particular method of manufacturing.

Extensive tests show that the exemplary acorn-shaped pellets manufactured according to the manufacturing process described herein are capable of withstanding approximately 1.5 hours of rain conditions while retaining 80% of their original rigidity and shape. Similar tests were performed on Imperial Whitetail Results Deer Feed, a product sold by Southern States Cooperative, Inc. that features water-resistant technology registered under the trademark RAINSHED™. After about 5 minutes of similar rain conditions, approximately half of the original Imperial Whitetail deer pellets had dissolved. After about 12 minutes, the pellets were completely dissolved.

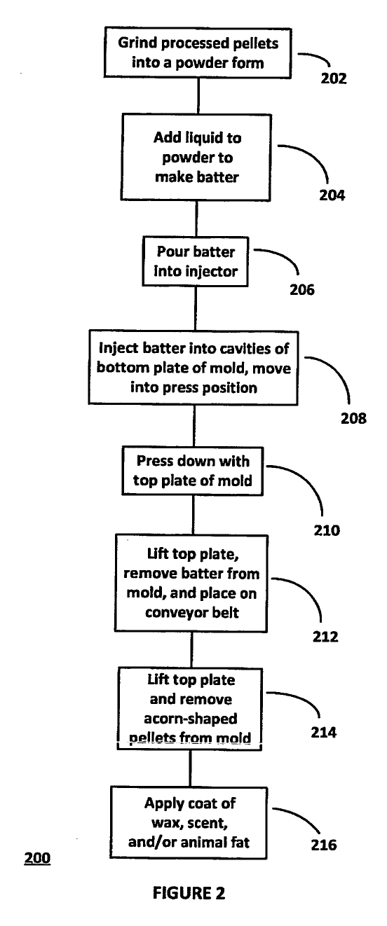

FIG. 2 is a flow chart showing an overview of a manufacturing process for producing another exemplary embodiment of the invention. In the first step, processed pellets are ground into a powder form, shown in block 202, and mixed with water and scent to form a batter, shown in block 204. The processed pellets can be supplied by a feed company. In an exemplary embodiment, the processed pellets contain the dry ingredients, and their portions, listed in Table 1. In some embodiments, some or all of the dry ingredients to be included are supplied in powder form. However, all or even most of the ingredients listed in Table 1 need not be included in every embodiment of the invention. The batter preferably comprises 30-40% water and 60-70% powder, by weight. These ranges are exemplary and do not limit the invention. Additionally, other liquids, such as corn syrup, could be used in place of water. In some embodiments, scent(s)/attractant(s) such as the ones described above are also included in the batter. In other embodiments, waxes such as paraffin and baker's wax such are included. Depending on the situation, it may be desirable to include both wax and scent/attractant. In an exemplary embodiment, a scent is added to the mixture.

In the next two steps, shown in blocks 206 and 208, the batter is scooped into an injector and injected into the bottom plate of a mold having top and bottom plates. In an exemplary embodiment, an injector such as the one shown in FIG. 3B is used. The injector of FIG. 3B comprises an air cylinder 314, a plunger 316, a spout 318, and a holding bin 320. The mold used in the manufacturing process described herein is the same mold that is shown in FIGS. 4-8 and described in detail above. The spout 318 of the injector is connected to feed tubes 402, shown in FIG. 4, which feed the batter into the mold. Once the bottom plate is moved into position and the batter is injected, the top plate presses down with about 300 PSI, shown in block 210. The top plate is then lifted and the acorn-shaped pellets are removed from the bottom plate using injector pins located in the bottom of the cavities, shown in block 212.

The acorn-shaped pellets are placed on a conveyor belt and carried through an industrial microwave, shown block 214. The industrial microwave serves multiple functions, which could alternatively be performed by other suitable equipment for drying. First, the microwave removes almost all of the moisture contained inside the acorn-shaped batter. Second, it bonds together the ingredients contained within the acorn-shaped batter while still retaining the shape of the acorn mold. Third, the industrial microwave kills bacteria that may have been present in the ingredients. Drying the acorn-shaped batter with such a heating device is a useful alternative to bonding the ingredients together by heating in a liquid sugar base. However, sugar or other ingredients could still be included in the batter for attractant purposes.

Furthermore, drying the acorn-shaped batter with the industrial microwave seals out moisture and creates a water resistant feed that can endure exposure to outdoor conditions, including rain, dew, snow, etc., for prolonged periods of time. Specifically, extensive tests show that the exemplary acorn pellets, manufactured according to the microwave process described herein, are capable of retaining 95% of the original rigidity and shape after 3 days of exposure to rain conditions. In addition to lasting longer than other deer feeds, the water resistant seal of the exemplary acorn pellets is created without the use or addition of any chemicals and other potentially harmful substances.

The final step, shown in block 216, is an optional step of coating or covering the acorn-shaped pellets. In some embodiments the acorn-shaped pellets are covered with attractants and/or scents, such as acorn scent, apple scent, or other attractants. In other embodiments, the acorn-shaped pellets are covered in wax such as paraffin or baker's wax. In other embodiments, the acorn-shaped pellets are covered in animal fat. Covering the acorn-shaped pellets in a scent/attractant helps attract deer to the feed once it is deposited onto the ground. Covering the pellets in wax and/or animal fat provides additional water resistance that is capable of withstanding exposure to outdoor conditions, including rain, dew, snow, etc., for prolonged periods of time. In an exemplary embodiment, a coating of wax is added. Approximately 9 grams of coating is used per pound of acorn-shaped pellets. These weights, sizes, and amounts are exemplary and do not limit the invention.

One embodiment resulting from the manufacturing process described herein is an exemplary deer feed pellet having a shape of an acorn and comprising wax, scent, the ingredients and their portions listed in Table 1, less than about 5% moisture, and water resistant properties without the addition of harmful chemical substances. The final weight of the exemplary acorn-shaped pellets described herein is about 4 grams. Other methods of manufacturing may also be used to arrive at the same exemplary embodiment described herein. The invention is not limited to this particular method of manufacturing.

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1. A method for making an animal feed, comprising the steps:
combining feed ingredients;
heating a liquid;
mixing the feed ingredients with the heated liquid to form a mixture;
introducing the mixture into a mold; and
forming, under pressure, the mixture into a solid having the shape of a naturally occurring object.

2. The method of claim 1, wherein the naturally occurring object is a naturally occurring food source for an animal, selected from the group consisting of an acorn, a walnut, a beech nut, a hedge apple, a wild blackberry, and a hickory nut.

3. The method of claim 1, further comprising the step adding at least one of a scent or a wax to the mixture.

4. The method of claim 1, wherein the liquid comprises at least one selected from the group consisting of water, molasses, corn syrup, or melted sugar.

5. The method of claim 1, wherein the feed ingredients comprise at least one selected from the group consisting of acorn products, plant protein products, processed grain by-products, roughage products, calcium carbonate, monocalcium phosphate, dicalcium phosphate, molasses products, forage products, biotin, sodium bentonite, salt, lignin sulfonate, calcium bentonite, sodium selenite, vitamin E supplement, vitamin A supplement, vitamin D supplement, zinc oxide, cobalt glucoheptonate, zinc amino acid complex, manganese amino acid complex, copper amino acid complex, manganous oxide, magnesium oxide, copper sulfate, manganese sulfate, zinc sulfate, ethylenediamine dihydriodide, cobalt carbonate, ferrous sulfate, pellet binder, limestone, urea, trace minerals, vitamin A, vitamin D, vitamin E, and crude fat.

6. The method of claim 1, further comprising drying by a microwave oven the formed solid.

7. The method of claim 1, wherein the feed ingredients make up about 40% by weight of the mixture.

8. The method of claim 1, further comprising the step covering the mixture with a protective coat selected from the group consisting of animal fat and wax, after forming under pressure.

9. A method for making an animal feed, comprising the steps:
mixing feed ingredients with a liquid to form a mixture;
forming, under pressure, the mixture into a solid having the shape of a naturally occurring object; and
drying the formed solid to remove moisture in the solid;
whereby the contents of the solid are bonded together to create a water resistant feed product having the shape of a naturally occurring object.

10. The method of claim 9, wherein the naturally occurring object is a naturally occurring food source for an animal, selected from the group consisting of an acorn, a walnut, a beech nut, a hedge apple, a wild blackberry, and a hickory nut.

11. The method of claim 9, wherein drying the formed solid comprises heating the formed solid with a microwave oven.

12. The method of claim 9, further comprising the step adding scent into the mixture before drying.

13. The method of claim 9, wherein the feed ingredients comprise at least one selected from the group consisting of acorn products, plant protein products, processed grain by-products, roughage products, calcium carbonate, monocalcium phosphate, dicalcium phosphate, molasses products, forage products, biotin, sodium bentonite, salt, lignin sulfonate, calcium bentonite, sodium selenite, vitamin E supplement, vitamin A supplement, vitamin D supplement, zinc oxide, cobalt glucoheptonate, zinc amino acid complex, manganese amino acid complex, copper amino acid complex, manganous oxide, magnesium oxide, copper sulfate, manganese sulfate, zinc sulfate, ethylenediamine dihydriodide, cobalt carbonate, ferrous sulfate, pellet binder, limestone, urea, trace minerals, vitamin A, vitamin D, vitamin E, and crude fat.

14. The method of claim 9, further comprising the step grinding the feed ingredients into a powder before mixing with the liquid.

15. The method of claim 9, further comprising the step applying a protective coating selected from the group consisting of wax and animal fat, after drying.

16. The method of claim 9, wherein the feed ingredients make up about 70% by weight of the mixture.

17. A composition comprising:
an animal feed comprising at least one selected from the group consisting of acorn products, plant protein products, processed grain by-products, roughage products, calcium carbonate, monocalcium phosphate, dicalcium phosphate, molasses products, forage products, biotin, sodium bentonite, salt, lignin sulfonate, calcium bentonite, sodium selenite, vitamin E supplement, vitamin A supplement, vitamin D supplement, zinc oxide, cobalt glucoheptonate, zinc amino acid complex, manganese amino acid complex, copper amino acid complex, manganous oxide, magnesium oxide, copper sulfate, manganese sulfate, zinc sulfate, ethylenediamine dihydriodide, cobalt carbonate, ferrous sulfate, pellet binder, limestone, urea, trace minerals, vitamin A, vitamin D, vitamin E, and crude fat;
wherein the animal feed has the shape of a naturally occurring object.

18. The composition of claim 17, wherein the naturally occurring object is a naturally occurring food source for an animal, selected from the group consisting of an acorn, a walnut, a beech nut, a hedge apple, a wild blackberry, and a hickory nut.

19. The composition of claim 17, further comprising at least one of a scent and a wax.

20. The composition of claim 17, wherein the composition contains less than about 5% moisture.
